(19) United States
(12) Patent Application Publication
(10) Pub. No.: US 2018/0101355 A1
(43) Pub. Date: Apr. 12, 2018

(54) METHOD AND DEVICE FOR ADAPTIVE AUDIO PLAYBACK IN A VEHICLE

(71) Applicants: Alexander van Laack, Aachen (DE); Peter Wasserfuhr, Koln (DE); Bertrand Stelandre, Thimister (BE)

(72) Inventors: Alexander van Laack, Aachen (DE); Peter Wasserfuhr, Koln (DE); Bertrand Stelandre, Thimister (BE)

(21) Appl. No.: 15/725,856

(22) Filed: Oct. 5, 2017

(30) Foreign Application Priority Data
Oct. 6, 2016 (DE) 10 2016 118 950 2

(51) Int. Cl. G06F 3/16; G10L 21/0232; H04R 1/40; H04R 29/00; H04R 3/04; H04R 3/12

(52) U.S. Cl. CPC G06F 3/165; G10L 21/0232; H04R 1/406; G10L 2021/02082; H04R 3/04; H04R 3/12; H04R 1/403; H04R 29/002

(57) ABSTRACT

A method and a device for adaptive audio playback in a vehicle are provided, The provided method and device enable an adaptation of the audio playback in the case of a change in the vehicle interior space configuration, which is caused by a change in the arrangement of the vehicle interior furnishings or by a change in the number and position of vehicle occupants. Specifically, the method provides for an audio signal to be played back into the vehicle interior space by at least one loudspeaker, and at least one microphone to acquire audio signals reflected by the vehicle interior space. An acoustic reflection profile associated with the vehicle interior space is generated using reflected audio signals. An audio playback profile, adapted to the associated vehicle interior space configuration, is then set for the playback of audio signals into the vehicle interior space.

### CROSS REFERENCE TO RELATED APPLICATION

This U.S. utility patent application claims the benefit of German patent application No. 10 2016 118 950 2, filed Oct. 6, 2016, the contents of which are incorporated herein by reference in its entirety.

### BACKGROUND

For an optimal audio signal playback result, sound systems installed in vehicles are adapted to the acoustic environment of the vehicle interior space or of the vehicle interior furnishings and configuration. In the process, taking into consideration reflection properties and absorption properties of the vehicle interior furnishings and, in particular, taking into consideration the seat positions of vehicle occupants in the vehicle interior space, several loudspeakers are usually arranged in such a manner that an optimal sound quality for the existing vehicle interior space configuration can be achieved. A change in the vehicle interior space configuration, which may be caused, for example, by a change in the number or the position of the vehicle occupants, or by a change in the number or position of baggage items, may cause the sound quality to be negatively affected, and which may require an adaption of the audio playback. Changes in the vehicle interior space configuration that are caused by movable or variable interior furnishings, such as, for example, by movable or removable seats which can be arranged differently for the variable adaptation of the vehicle interior space, can also lead to a disadvantageous change in the sound quality in the vehicle interior space. Such changes in the vehicle interior space configuration can usually not be compensated by preset sound systems, so an adaptation of the audio playback can be achieved only by manual adjustments by a user.

From DE 10 2009 022 685 A1, a method is known for exposing vehicle occupants to sound, in which a first seat occupation state of the vehicle is determined, and subsequently a playback characteristic for the playback of audio signals depending on the seat occupation state is set. The process for the acquisition of the seat occupation uses sensors arranged on the seat. Baggage items or changes in the vehicle interior furnishings are not taken into consideration in the adaptation of the playback characteristics.

Moreover, a method for regulating the sound level is known from DE 42 02 609 A1, which discloses a test signal emitted in a listening space, and being received by a microphone, and adapting the sound level depending on the difference between the test signal and the received signal.

EP 1 882 387 B1 discloses a sound system for a vehicle, which includes sound zones personalized for vehicle occupants are created, in order to suppress extraneous noise. In the process, the user can select from different sound zone configurations.

No solution is known from the prior art which, takes into consideration the entire vehicle interior space configuration or a change in the vehicle interior space configuration, for the adaptation of the sound quality of the audio playback in a vehicle.

### SUMMARY

A method and a device for adaptive audio playback in a vehicle are provided. The provided method enables an adaptation of the audio playback in the case of a change in the vehicle interior space configuration, which is caused by a change in the arrangement of the vehicle interior furnishings or by a change in the number and position of vehicle occupants.

An aim of the invention is to provide a method and a device to provide a simple adaptation of the sound quality of the audio playback in vehicles in response to a change in the vehicle interior space configuration.

The method provided for adaptive audio playback in a vehicle with a sound system, which comprises an arrangement of at least two loudspeakers and at least one microphone, includes an audio signal being played back into the vehicle interior space by means of at least one loudspeaker, and audio signals reflected by the vehicle interior space are acquired by means of the at least one microphone. An acoustic reflection profile of the vehicle interior space is generated using the reflected audio signals, and the generated acoustic reflection profile is associated with a vehicle interior space configuration. An audio playback profile, adapted to the associated vehicle interior space configuration, is then generated for the playback of audio signals into the vehicle interior space.

According to the disclosure, an acoustic reflection profile of the interior space, and based on the audio signals reflected on the interior space of the vehicle, is generated. Here, use is made of the fact that bodies and objects present in the vehicle interior space, such as vehicle occupants, baggage items and vehicle interior furnishings, have different characteristic absorption properties or reflection properties for certain frequencies, so that these objects and bodies can be distinguished from one another based on the reflected audio signals, Preferably, the audio signal played back into the vehicle interior space covers a broad frequency range, in order to obtain a large information content of the reflected audio signals. Advantageously, a comparison of a frequency range or of a frequency profile of an audio signal played back into the vehicle interior space with a frequency range or a frequency profile of reflected audio signals can be used for the generation of the acoustic reflection profile.

For the sake of simplicity, the acoustic reflection profile feature is referred to as a “reflection profile” below. The reflection profile can represent a mapping of the vehicle interior space configuration in the form of a heat map, from which it is possible to determine whether bodies and objects are present in the vehicle interior space, and how the bodies and objects are arranged. Such bodies and objects may include, for example, occupants, baggage and variable interior furnishings such as, for example, seats. For the interpretation of the reflection profile of the vehicle interior space, reflection reference profiles of different bodies and/or objects such as, for example, of the human body, of animal bodies, in particular dog bodies, of baggage items or of the interior furnishings, in particular the seats, can be used. Advantageously, based on the reflection profile, a number and/or position of vehicle occupants and/or baggage items and/or changeable vehicle interior furnishings can be acquired without having to use additional sensors or cameras.

Advantageously, in a generation of the reflection profile, a number of occupants and/or an occupant seat position and/or a number of baggage items and/or a baggage item position and/or an arrangement of the vehicle interior furnishings and/or a number of moveable or variable vehicle interior components can be taken into consideration. Moreover, it is possible to provide that stationary objects or bodies which do not change in terms of their number and position or arrangement in the vehicle interior space are not taken into consideration in the generation of the reflection profile and therefore not displayed in the reflection profile. Therefore, it is possible to be able to better identify changed objects or bodies. Advantageously, stationary vehicle interior components can be left out of consideration in the generation of a reflection profile.

Since objects and bodies present in the vehicle interior space can have different audio signal absorption properties and reflection properties, it can be necessary that the played back audio signals have a certain frequency in order to be able to recognize objects or bodies based on their reflected audio signals. Therefore, it is possible to provide that an audio signal with a predetermined frequency range is played back into the vehicle interior space.

Moreover, acoustic reflection profiles of different vehicle interior space configurations can be provided, wherein an audio playback profile is associated with each vehicle interior space configuration for the optimal sound playback. A vehicle interior space configuration can therefore be determined by comparison of a reflection reference profile with the generated reflection profile. By setting the audio playback profile associated with the determined vehicle interior space configuration, an optimal playback quality of audio data to be played back can be achieved.

Since changes in the entire vehicle interior space configuration can be determined directly, the method according to the invention enables a dynamic adaptation of the audio playback profile for the sound optimization of the audio signals to be played back. Therefore, the setting of the audio playback profile can comprise a modulation of the frequency or of the amplitude of the audio signal or of parts of the audio signal or a time delay of the audio signal to be played back.

According to an advantageous design variant of the provided method, a microphone can be associated with a group of at most three loudspeakers, wherein audio signals played back by the group of loudspeakers are acquired by the associated microphone. According to a preferred development of the method, exactly one microphone can be associated with each loudspeaker, wherein audio signals played back by a loudspeaker are acquired only by the microphone associated with the loudspeaker. In an additional variant, it is possible to provide that at least two microphones are associated with a loudspeaker, wherein audio signals played back by a loudspeaker are acquired only by the microphones associated with the loudspeaker. Due to the number of microphones associated with a loudspeaker, which can preferably be arranged spaced apart, the resolution for the acquisition of reflected audio signals can be influenced, wherein a larger number of microphones means a better resolution.

Moreover, it is possible to provide that a vehicle speed is taken into consideration in the setting of the audio playback profile.

In the setting of an audio playback profile, rendering settings of a renderer can be adapted for rendering audio data. Preferably, individual loudspeakers can be controlled independently of one another, wherein audio signals to be played back are rendered separately for each loudspeaker in order to achieve an adaptation of the sound quality. Advantageously, by means of a change in the vehicle interior space configuration, a change in the rendering settings can be achieved.

The disclosure further relates to a device for adaptive audio playback in a vehicle. According to the invention, the device comprises at least two loudspeakers arranged in a vehicle interior space for playing back audio signals into the vehicle interior space, at least one microphone arranged in the vehicle interior space for the acquisition of audio signals reflected on the vehicle interior space, a processor which is set up in order to generate an acoustic reflection profile of the vehicle interior space based on the reflected audio signals and to associate a generated reflection profile with a vehicle interior space configuration, and in order to set, based on an associated vehicle interior space configuration, an audio playback profile for playing back audio signals into the vehicle interior space. Moreover, the device according to the invention comprises a renderer coupled to the processor and set up for the playback of the set audio playback profile.

For the provision of audio data, the device according to the invention can comprise a storage medium or a drive for a storage medium. Audio data can also be provided wirelessly to the device according to the invention, wherein the device comprises an interface for wireless communication such as, for example, a WLAN and/or Bluetooth module. The audio data provided to the device are processed by the processor.

According to an advantageous development of the device according to the disclosure, a microphone can be associated with a group of at most three loudspeakers. Alternatively, exactly one microphone can be associated with each loudspeaker. However, it is also possible to provide an arrangement of the device according to the invention, in which at least two microphones are associated with a loudspeaker. Here, it is moreover possible to provide that individual microphones are associated at the same time with at least two loudspeakers. As a result of the fact that, according to a design variant, at least two microphones are associated with each loudspeaker, an improved resolution in the acquisition of the reflected audio signals can be achieved, so that the setting of the reflection profile and the association with a vehicle interior space configuration are facilitated. Due to the facilitated association, an adaptation of the playback profile, that is to say of the audio playback, with reduced time delay can be achieved.

Preferably, at least two microphones and at least two loudspeakers can be arranged on opposite sides in the vehicle interior space.

According to an advantageous development of the invention, in which reflection profiles of certain areas of the vehicle interior space are to be acquired, a loudspeaker and a microphone associated with the loudspeaker or at least two microphones associated with the loudspeaker can be arranged at a predetermined angle and/or at a predetermined spacing from each other.

In an advantageous development of the device according to the invention, it is moreover possible to provide that a loudspeaker and/or a microphone associated with the loudspeaker is/are arranged on a movable or changeable vehicle interior component such as a seat or a headrest for example.

Preferably acoustic reflection reference profiles of different vehicle interior space configurations can be stored in the processor. A vehicle interior space configuration can take into consideration a number of occupants and/or an occupant seat position and/or a number of baggage items and/or a baggage item position and/or an arrangement of the vehicle interior furnishings and/or a number of movable vehicle interior components.

The setting of a changed audio playback profile can require a change in the rendering settings of audio data to be rendered. Here, it is possible to provide that rendering settings for individual loudspeakers must be adapted in order to obtain an adaptation of the sound quality. Advantageously, it is possible to provide that the renderer is set up for individual control of the loudspeakers.

### BRIEF DESCRIPTION OF THE DRAWINGS

Further details, features and advantages of designs of the invention result from the following description of embodiment examples in reference to the associated drawings.

FIG. 1 shows a flowchart of an embodiment example of the method according to the present disclosure for the adaptive audio playback in a vehicle,

FIG. 2a shows a diagrammatic representation of an embodiment example of the device according to the present disclosure for adaptive audio playback in a vehicle during audio playback into the vehicle interior space;

FIG. 2b shows a diagrammatic representation of an embodiment example of a device for adaptive audio playback in a vehicle during audio playback into the vehicle interior space;

FIG. 3a shows a diagrammatic representation of an embodiment example of a device for adaptive audio playback in a vehicle during audio playback into the vehicle interior space;

FIG. 3b shows a diagrammatic representation of an embodiment example of a device for adaptive audio playback in a vehicle during audio playback into the vehicle interior space;

FIG. 4 shows a diagrammatic representation for the explanation of the principle of a method provided for adaptive audio playback in a vehicle; and

FIG. 5 shows a flowchart of an additional embodiment example of a method for adaptive audio playback in a vehicle.

### DETAILED DESCRIPTION

Recurring features are marked with identical reference numerals in the figures.

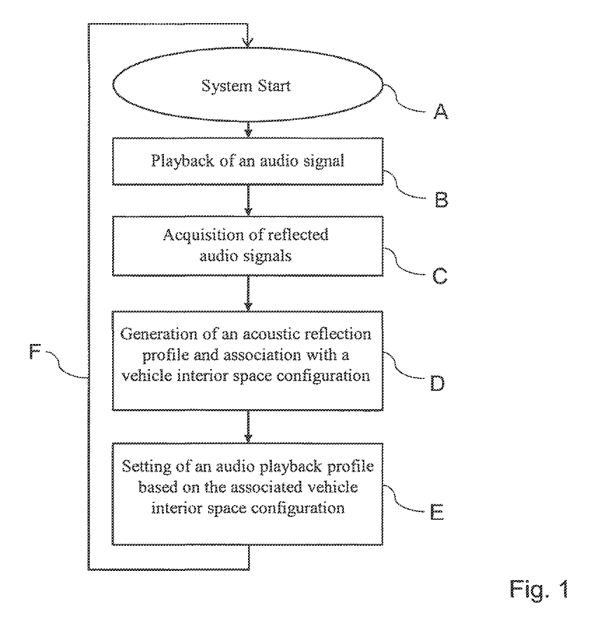

FIG. 1 shows a flowchart of an embodiment example of the method according to the invention for adaptive audio playback in a vehicle. The method is activated by switching on a sound system (not shown) present in a vehicle, which comprises an arrangement of several loudspeakers and microphones, as marked with step “A” in FIG. 1. In the next step, “B”, a predetermined audio signal which has a predetermined frequency range is played back into the vehicle interior space, by at least one loudspeaker. Some frequency components of the played back audio signal are absorbed by the vehicle interior space, and other frequency components of the played back audio signal are reflected by the vehicle interior space. The audio signals reflected by the vehicle interior space are acquired in step “C” by at least one microphone. The reflected signals of vehicle occupants, baggage and vehicle interior furnishings are taken into consideration. In step “D”, an acoustic reflection profile of the vehicle interior space is generated using the reflected audio signals. The generated acoustic reflection profile is associated with a vehicle interior space configuration. Reflection reference profiles of known vehicle interior space configurations can be provided for the association with the vehicle interior space configuration. Such known reflection reference profiles may be compared with the generated reflection profiles. A vehicle interior space configuration may take into consideration a number of occupants and/or an occupant seat position and/or a number of baggage items and/or a baggage item position and/or an arrangement of the vehicle interior furnishings and/or a number of movable vehicle interior components. In step “E”, an audio playback profile adapted to the associated vehicle interior space configuration is set for playback of audio signals into the vehicle interior space. Therefore, an audio playback that is optimal for the vehicle interior space configuration is provided.

The arrow marked “F” clarifies that the method can be repeated periodically, in order to be able to directly determine a change in the vehicle interior space configuration. By direct determination of a change in the vehicle interior space configuration. The audio playback can be adapted without substantial time delay, so that the adaptation of the audio playback is not perceivable or barely perceivable by the listener.

The audio playback profile consists of settings for the playback of audio signals via multiple loudspeakers, wherein the audio signals to be played back are modulated with regard to their amplitude, their frequency or a playback delay. The playback settings of an audio playback profile can be carried out by a processor. Moreover, it is possible to provide that the playback profile comprises rendering settings for rendering audio data, so that audio data for playback can be rendered individually for each loudspeaker.

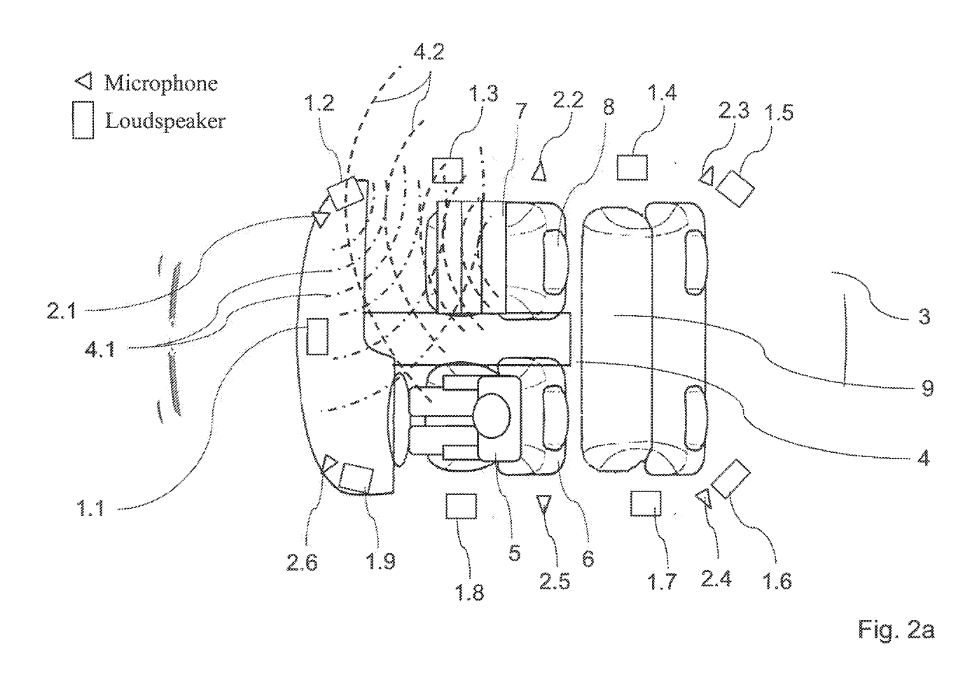

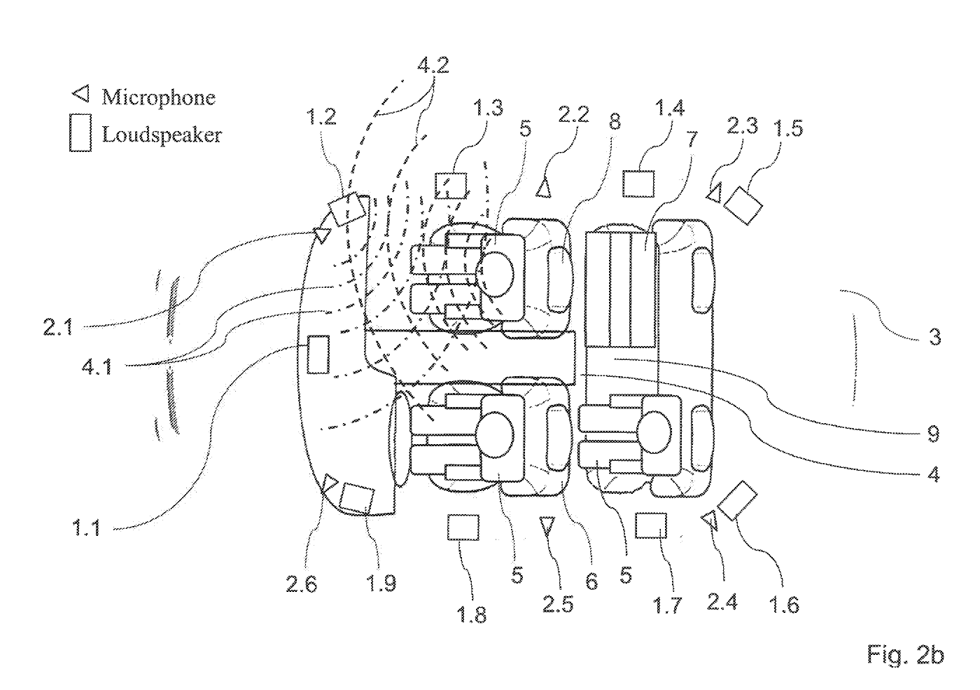

FIGS. 2a and 2b each show a respective representation of an embodiment example of the device according to the invention for adaptive audio playback in a vehicle 3 during audio playback into the vehicle interior space 4, wherein, in the vehicle interior space 4, according to FIG. 2a, an occupant 5 is sitting in the driver's seat 6, and a baggage item 7 is arranged on a front passenger seat 8, and wherein, according to FIG. 2b, in each case one occupant 5 is sitting in the driver's seat 6, in the front passenger seat 8, and in the back seat 9, and a baggage item 7 is arranged on the back seat 9.

Marked using reference numerals 1.1 to 1.9 are nine loudspeakers arranged in the vehicle interior space for playback of audio signals. Moreover, six microphones 2.1 to 2.6 are arranged in the vehicle interior space 4 in such a manner that in each case three microphones are present on each side of the vehicle interior space 4. The semicircular chain dotted lines illustrate audio signals 4.1 played back into the vehicle interior space 4 by means of the loudspeaker 1.2. The audio signal 4.1 played back into the vehicle interior space 4 is partially absorbed by the objects and bodies present in the vehicle interior space 4 and partially reflected, wherein audio signals 4.2 reflected on the vehicle interior space 4 in the front area on the right are illustrated with chain dotted lines.

In the embodiment example illustrated in Fig, 2a, the audio signals 4.1 reproduced by the loudspeakers 1.1 to 1.9 are reflected from the occupant 5 in the driver's seat 6, from the front passenger seat 8, from the baggage item 7 on the front passenger seat 8, and from the back seat 9.

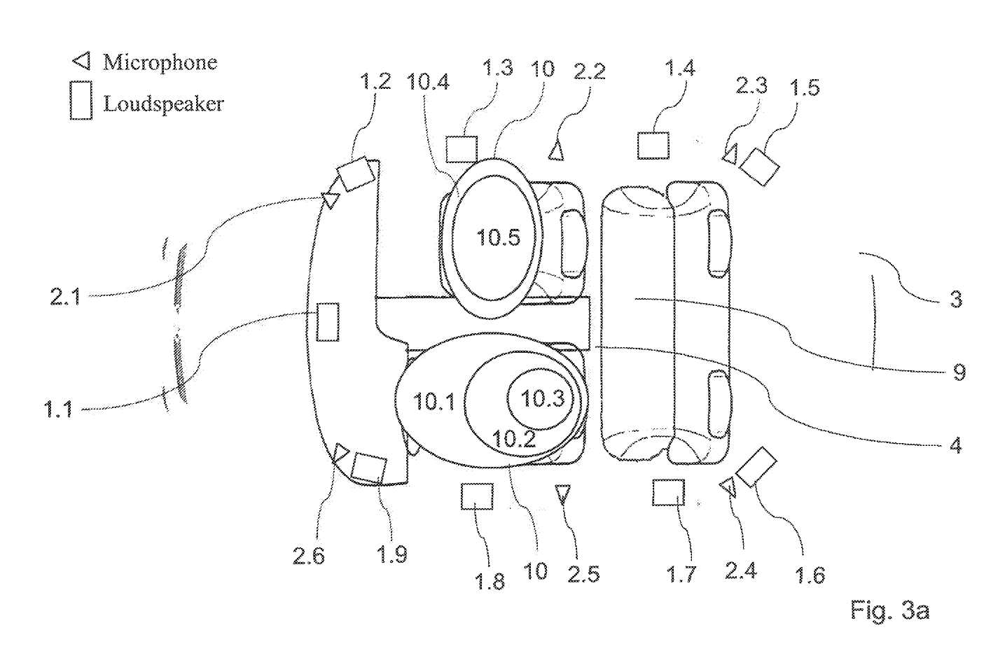

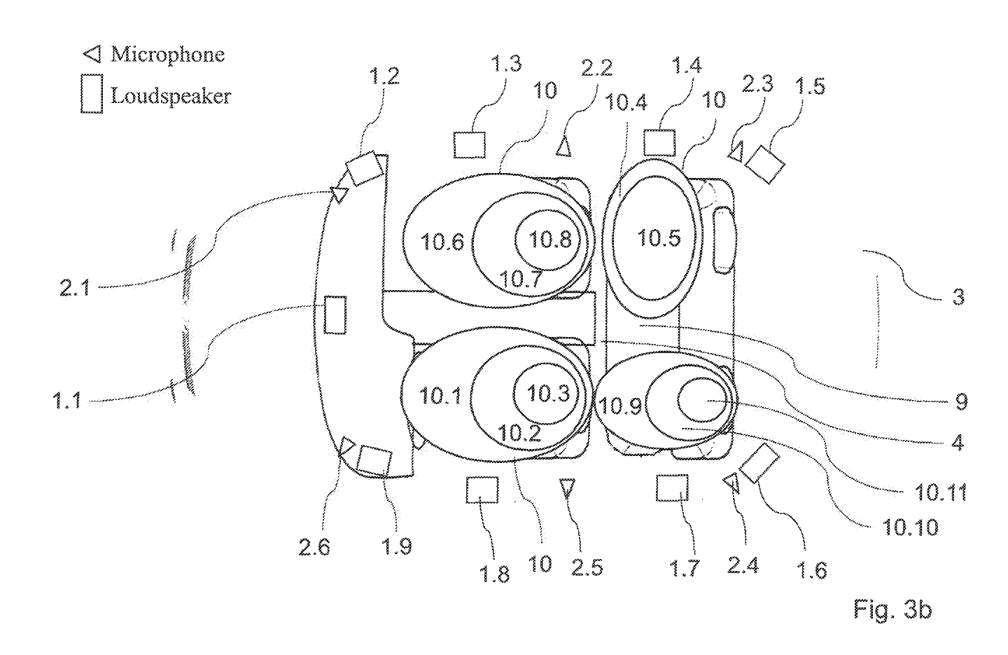

The vehicle interior space configuration relates to the arrangement of the front seats 6 and 8, the arrangement of the back seat 9, and the positions of the occupant 5 in driver position and of the baggage item 7. The audio signals 4.2 reflected from the vehicle interior space configuration are acquired by the microphones 2.1 to 2.6 and transmitted to a processor (not shown), which is configured to generate an acoustic reflection profile (FIG. 3a) of the vehicle interior space 4 based on the reflected audio signals 4.2 and to associate a generated reflection profile with a vehicle interior space configuration, and in order to set, based on an associated vehicle interior space configuration, an adapted audio playback profile for the playback of audio signals into the vehicle interior space 4. Furthermore, the device may comprise a renderer (not shown) which is coupled to the processor and configured for playback of the set audio playback profile.

In the embodiment example illustrated in FIG. 2b, the audio signals 4.1 played back by the loudspeakers 1.1 to 1.9 are reflected on the occupant 5 sitting in the driver's seat 6 and on the driver's seat 6, on the occupant 5 sitting in the front passenger seat 8 and on the front passenger seat 8, and on the occupant 5 sitting in the back seat 9, as well as on the baggage item 7 deposited on the back seat and on the back seat 9. The vehicle interior space configuration relates to the arrangement of the front seats 6 and 8, the arrangement of the back seat 9, and the position of the occupants 5 as well as of the baggage item 7. The audio signals 4.2 which are again reflected on the vehicle interior space configuration are acquired by the microphones 2.1 to 2.6 and transmitted to the processor, not shown, which is set up in order to generate, based on the reflected audio signals 4.2, an acoustic reflection profile (FIG. 3b) of the vehicle interior space 4, and to associate a generated reflection profile with a vehicle interior space configuration, and in order to set, based on an associated vehicle interior space configuration, an adapted audio playback profile for playback of audio signals into the vehicle interior space 4.

For the generation of the acoustic reflection profile, it is possible to provide that reflected audio signals 4.2 are taken into consideration only from certain areas of the vehicle interior space 4. For this purpose, the microphones 2.1 and 2.2 can be associated with the loudspeakers 1.2 and 1.3 in order to acquire reflected audio signals from the right front area of the vehicle interior space 4. For the acquisition of reflected audio signals from the left front area of the vehicle interior space 4, the microphones 2.5 and 2.6 can be associated with the loudspeakers 1.8 and 1.9. Moreover, it is possible to provide that the microphones are associated with at least two loudspeakers at the same time or with a group of loudspeakers of different areas of the vehicle interior space 4. Therefore, the microphones 2.2 and 2.3 can be associated with the loudspeakers 1.4 and 1.5 in order to acquire reflected audio signals from the right rear area of the vehicle interior space 4. On the opposite side, the microphones 2.4 and 2.5 can be associated with the loudspeakers 1.6 and 1.7 in order to acquire reflected audio signals from the left rear area of the vehicle interior space 4. In the front area, the microphones 2.1 and 2.6 can be associated with the loudspeakers 1.1, 1.2 and 1.9, so that, together with the audio signals from the front right and left area, an improved resolution of reflected audio signals in the front area can be achieved. An association of loudspeakers and microphones can be implemented by the method according to the invention.

The representations according to FIGS. 3a and 3b correspond to the representations according to FIG. 2a and 2b, wherein, in each case, an acoustic reflection profile 10 generated according to the method according to the invention is shown. The acoustic reflection profile 10 comprises in each case several reflection zones 10.1 to 10.5, or 10.1 to 10.11, wherein the reflection zones 10.1 to 10.3 generated in the front left area represent the occupant 5 sitting in the front left seat, that is to say the driver's seat 6. The reflection zones 10.4 and 10.5 generated according to FIG. 3a in the front right area and according to FIG. 3b in the rear right area of the vehicle interior space 4 represent the baggage item 7 arranged on the front right seat, that is to say the front passenger seat 8, according to FIG. 3a, or on the back seat 9, according to FIG. 3b.

The reflection zones 10.6 to 10.8 generated according to FIG. 3b in the front right area of the vehicle interior space 4 represent the occupant 5 sitting in the front right seat, that is to say the front passenger seat 8, while the reflection zones 10.9 to 10.11 generated in the rear left area represent the occupant 5 sitting in the back seat 9.

An interpretation of the reflection profile 10 can be achieved by comparison with reflection reference profiles on the basis of which bodies, objects and the arrangement thereof can be identified. In the reflection profile 10 shown, stationary objects such as the seats 6 and 8 as well as the back seat 9 are not taken into consideration and not displayed, since they are not changed in comparison to a presetting for this vehicle interior space configuration. To the extent that the seats 6, 8 and/or the back seat 9 are changed in terms of their arrangement, this change is acquired by changed reflected audio signals and taken into consideration accordingly in the reflection profile, so that an audio playback profile which is adapted to the change can be set.

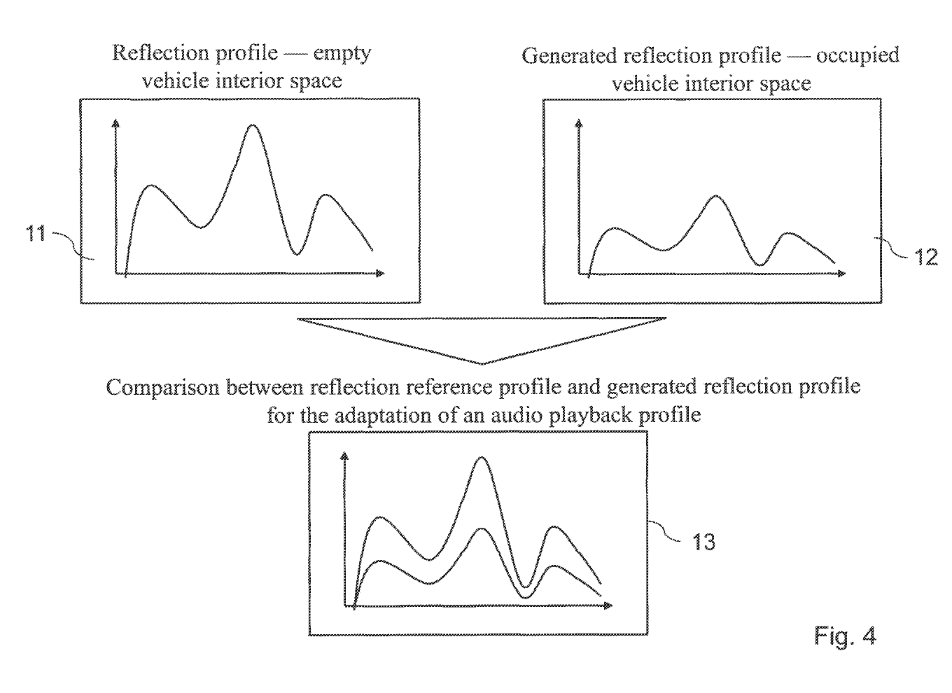

FIG. 4 shows a diagrammatic representation for explanation of the principle of the method for adaptive audio playback in a vehicle 3 based on reflection profiles which, in contrast to the representation in FIGS. 3a and 3b, are represented in the form of line diagrams. Reference numeral 11 marks a reflection profile of a vehicle interior space configuration without vehicle occupants, wherein an audio playback profile which is optimal for this vehicle interior space configuration is set for playback of audio signals into the vehicle interior space. Marked with reference numeral 12 is a reflection profile which is generated based on reflected audio data of a vehicle interior space with a vehicle interior space configuration which is changed in comparison to the reflection reference profile 11. In contrast to the reflection profile 11 with empty vehicle interior space, occupants are present in the vehicle interior space of the generated reflection profile 12, so that the reflection profiles 11 and 12 differ from one another, as represented in the diagram as comparison 13 of the reflection profiles 11, 12. Based on the recognized difference, an adaptation of the association to a changed vehicle interior space configuration can be carried out. The audio playback profile can then be adapted accordingly, in other words, the audio playback profile can be set for playback of audio data into the changed vehicle interior space.

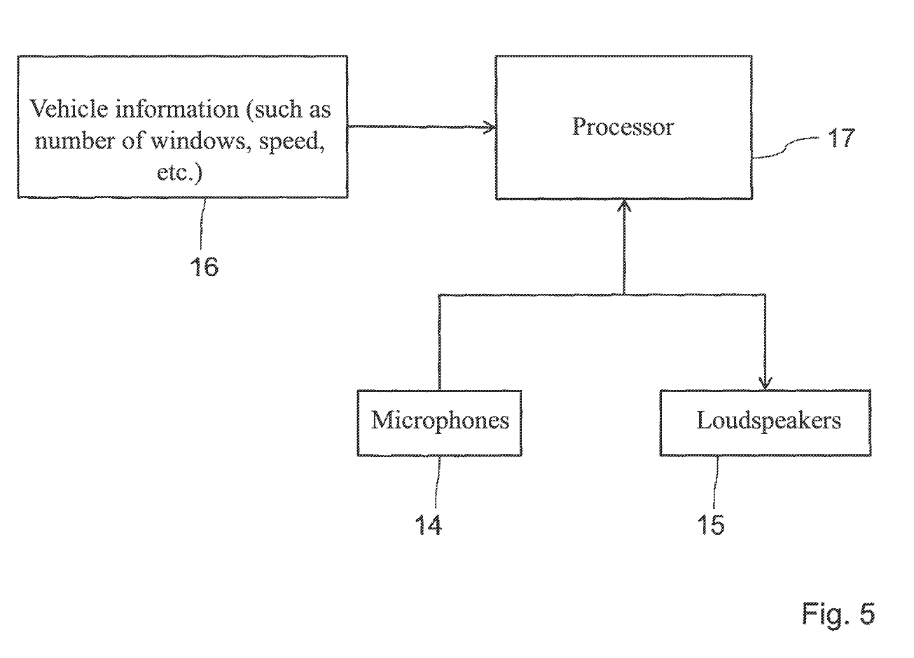

FIG. 5 shows a flowchart of another embodiment example of the method according to the invention for adaptive audio playback in a vehicle, wherein, for the adaptation of the audio playback into a vehicle interior space, in addition to reflected audio signals of the vehicle interior space, additional information on the vehicle state such as, for example, number of windows and/or vehicle speed, are taken into consideration. Corresponding vehicle information 16, which is stored in an onboard computer or determined by an onboard computer, can be transmitted to the processor 17. In addition to the reflected audio signals acquired by the microphones 14 in the vehicle interior space, the transmitted vehicle information 16 may be taken into consideration in the adaptation of the audio playback profile for the playback of audio signals via the loudspeakers 15.

What is claimed is:

1. A method for adaptive audio playback in a vehicle interior space using an arrangement of at least one loudspeaker and at least one microphone, and comprising:
playing an audio signal is into the vehicle interior space by the at least one loudspeaker;
acquiring by the at least one microphone, reflected audio signals as the audio signal reflected by the vehicle interior space;
generating an acoustic reflection profile of the vehicle interior space using the reflected audio signals;
associating the generated acoustic reflection profile with a vehicle interior space configuration; and
setting an audio playback profile adapted to the associated vehicle interior space configuration for the playback of audio signals into the vehicle interior space.

2. The method according to claim 1, further including the step of detecting a number and or a position of vehicle occupants and/or baggage items using the acoustic reflection profile.

3. The method according to claim 1, wherein acoustic reflection profiles of different vehicle interior space configurations are provided, with each vehicle interior space configuration being assigned an audio playback profile.

4. The method according to claim 1, wherein the step of generating an acoustic reflection profile of the vehicle interior space using the reflected audio signals further includes considering at least one of a number of occupants and/or an occupant seat position and or a number of baggage items and or a baggage item position and/or an arrangement of the vehicle interior furnishings and/or a number of movable vehicle interior components.

5. The method according to claim 1, wherein an audio signal with a predetermined frequency range is played back into the vehicle interior space.

6. The method according to claim 1, wherein a microphone is associated with a group of at most three loudspeakers, and wherein audio signals played back by the group of loudspeakers are acquired by the associated microphone.

7. The method according to claim 1, wherein exactly one microphone is associated with each loudspeaker, and wherein audio signals played back by a loudspeaker are acquired only by the microphone associated with the loudspeaker.

8. The method according to claim 1, wherein at least two microphones are associated with each loudspeaker.

9. The method according to claim 1, wherein a vehicle speed is taken into consideration in setting the audio playback profile.

10. The method according to claim 1, wherein the step of setting an audio playback profile further includes adjusting the rendering settings of a renderer for the rendering of audio data.

11. A device for adaptive audio reproduction in a vehicle, comprising:
at least one microphone arranged in a vehicle interior space for the acquisition of audio signals reflected from the vehicle interior space; and
a processor configured to generate an acoustic reflection profile of the vehicle interior space based on the reflected audio signals, and to associate a generated acoustic reflection profile with a vehicle interior space configuration, and to set an audio playback profile based on an associated vehicle interior space configuration, for the playback of audio signals into the vehicle interior space.

12. The device according to claim 11, further including a group of at least one loudspeaker;
wherein the at least one microphone is associated with the group of at least one loudspeaker; and
wherein the group of at least one loudspeaker includes at most three loudspeakers.

13. The device according to claim 11, further including at least one loudspeaker, and wherein exactly one microphone is associated with the at least one loudspeaker.

14. The device according to claim 11, further including at least one loudspeaker, and wherein at least two microphones are associated with the at least one loudspeaker.

15. The device according to claim 11, further including at least two loudspeakers, and wherein the at least two microphones are arranged on an opposite side of the vehicle interior space from the at least two loudspeakers.

16. The device according to claim 11, further including a loudspeaker;
and wherein the at least one microphone includes a microphone associated with the loudspeaker;
and wherein the loudspeaker and the microphone associated with the loudspeaker are arranged at a predetermined angle and or a predetermined spacing from one another.

17. The device according to claim 11, wherein the at least one microphone is arranged on a movable or changeable vehicle interior component.

18. The device according to claim 11, further including a loudspeaker;
wherein the at least one microphone includes a microphone associated with the loudspeaker; and
wherein at least one of the loudspeaker or the microphone associated with the loudspeaker are arranged on a movable or changeable vehicle interior component.

19. The device according to claim 11, wherein acoustic reflection reference profiles of different vehicle interior space configurations are stored in the processor.

20. The device according to claim 11, further including a renderer coupled to the processor for adapting audio based upon the audio playback profile for playback into the vehicle interior space; and
wherein the audio playback profile is dependent upon the vehicle interior space configuration, to provide for an improved audio quality within the vehicle interior space.
